(19) United States
(12) Patent Application Publication
(10) Pub. No.: US 2016/0090759 A1
(43) Pub. Date: Mar. 31, 2016

(54) MOTOR VEHICLE LOCK

(71) Applicant: Brose Schliesssysteme GmbH & Co. KG, Wuppertal (DE)

(72) Inventors: David Rosales, Rochester Hills, MI (US); Michael Wittelsbuerger, Lake Orion, MI (US); Stepan Hanke, Lake Orion, MI (US)

(21) Appl. No.: 14/871,601

(22) Filed: Sep. 30, 2015

Related U.S. Application Data
(60) Provisional application No. 62/058,093, filed on Sep. 30, 2014.

(51) Int. Cl. E05C 3/16; E05B 1/00; E05B 79/22; E05C 3/22; E05B 79/20

(52) U.S. Cl. CPC E05C 3/16; E05C 3/22; E05B 79/20; E05B 79/22; E05B 1/00

(57) ABSTRACT

A motor vehicle lock for a motor vehicle door arrangement is provided. An actuation chain is provided for performing an actuation cycle, which actuation chain may be brought into different operational states, wherein the actuation chain comprises a moveable first actuation element and a moveable second actuation element. It is proposed that the actuation chain comprises a moveable transition element and wherein during a first actuation phase of the actuation cycle the transition element interacts with at least one of said actuation elements, in particular with both actuation elements, and thereby adjusts the two actuation elements relative to each other, wherein in a subsequent actuation phase of the actuation cycle the first actuation element, depending on the operational state, drives the second actuation element.

### CLAIM OF PRIORITY

This application claims the benefit of U.S. Provisional Application No. 62/058,093, filed Sep. 30, 2014, the content of which is herein incorporated by reference in its entirety.

### FIELD OF THE TECHNOLOGY

The application is directed to a motor vehicle lock for a motor vehicle door arrangement. The application is also directed to a method for operating such a motor vehicle lock for a motor vehicle door arrangement.

### BACKGROUND

The motor vehicle lock in question is assigned to a motor vehicle door arrangement which comprises at least a motor vehicle door. The expression “motor vehicle door” is to be understood in a broad sense. It includes in particular side doors, back doors, lift gates, trunk lids or engine hoods. Such a motor vehicle door may generally be designed as a sliding door as well.

Today's motor vehicle locks normally comprise an actuation chain which provides a mechanical connection between an outer door handle or an inner door handle and the pawl of the motor vehicle lock. Via such an actuation chain the pawl may be deflected by an operation of the respective door handle. As the pawl is assigned to a catch, which interacts with a lock striker or the like, deflecting the pawl leads to opening of the motor vehicle lock and as a result to opening of the motor vehicle door.

The known motor vehicle lock (DE 10 2004 014 550 A1), which is the starting point for the invention, comprises an actuation chain, which provides a connection between an outer door handle and the pawl. The actuation chain comprises a movable first actuation element, which is assigned to the door handle, and movable second actuation element, which is assigned to the pawl. In order to realize a coupling operation state of the actuation chain, a movable coupling element is provided between the two actuation elements.

A disadvantage of the known motor vehicle lock is the fact that the interaction between the two actuation elements requires tight tolerances for the positioning of the respective engagement contours of the actuation elements. Without those tight tolerances malfunction with respect to the interaction of the actuation elements in particular with respect to the coupling element may occur.

The above noted tight tolerances lead to high manufacturing costs and to a decrease in robustness of the motor vehicle lock. This is true not only for the above noted, known motor vehicle lock providing a switchable coupling between an outer door handle and the pawl, but more generally for all actuation chains in a motor vehicle lock which require the direct or indirect interaction of two actuation elements. This is, for example true for crash coupling arrangements that decouple the actuation elements in case of a crash. This is also true for closing aids, which provide a switchable coupling between a closing lever and a catch of the motor vehicle lock.

### SUMMARY

It is therefore the object of the invention to provide a motor vehicle lock for a motor vehicle door arrangement with two actuation elements, which interact with each other during an actuation cycle, which motor vehicle lock guarantees a robust direct or indirect interaction between the actuation elements with low manufacturing costs.

The above noted object is realized by providing the actuation chain of the motor vehicle lock with a movable transition element, wherein during a first actuation phase of the actuation cycle the transition element interacts with at least one of said actuation elements, in particular with both actuation elements, and thereby adjusts the two actuation elements relative to each other. It is of particular importance that in a subsequent actuation phase of the actuation cycle the first actuation element, depending on the operational state, drives the second actuation element.

According to the invention it has been understood that the motor vehicle lock may be of simple mechanical structure, without having to realize tight tolerances, if the actuation elements, before their interaction with each other, are being adjusted by a respective transition element.

In further detail the actuation chain comprises a movable transition element, wherein during a first actuation phase of the actuation cycle the transition element interacts with at least one of the above noted actuation elements, in particular with both actuation elements, and thereby adjust the two actuation elements relative to each other. After the adjustment, in a subsequent actuation phase of the actuation cycle, the first actuation element, depending on the operational state, drives the second actuation element.

Accordingly, the invention is based on the idea to adjust the two actuation elements to each other with an transition element, before the interaction of the two actuation elements takes place. With this it is possible that the positioning of the two actuation elements is mainly defined by the transition element, and not by the actuation elements or their respective installations.

In an embodiment, the actuation chain may be brought into at least two operational states, namely a coupling operational state, in which the actuation elements are coupled to each other, and a decoupling operational state, in which the actuation elements are decoupled from each other. According to the operational state, the second actuation element may be driven or may not be driven by the first actuation element.

In an embodiment, a second actuation phase of the actuation cycle is provided, during which the actuation chain enters the coupled operational state or the decoupled operational state. This is foreseen depending on a actuation rapidity and/or a lock state of a lock mechanism. In the first alternative the decoupled operational state may be guaranteed for a crash situation.

Various embodiments include a transition element, which can be realized as a pivotable transition lever. According to an embodiment, at least a part of the first actuation element, here the deflection lever of the first actuation lever, is free from the transition lever. This means that this respective part of the actuation element may interact with the second actuation element, without being hindered by the transition element.

In an embodiment, the second actuation phase is followed by a third actuation phase of the actuation cycle, during which, depending on the operational state of the actuation chain, the first coupling element drives the second coupling element or the first coupling element runs free with respect to the second coupling element.

In various embodiments a lock mechanism is provided which controls the operational state of the actuation chain dependent from the lock state. According to an embodiment, the lock mechanism, when in the lock state “locked” acts on at least one actuation element to prevent the actuation chain to enter the coupled operational state. It may lead to a mechanical simple structure to block at least one actuation element such that the actuation chain may not enter the coupled operational state.

Another embodiment is based on the idea to have the lock mechanism influence the above noted adjustment of the actuation elements to each other such that the actuation chain entering the coupled operational state is prevented. This is particularly interesting as different lock states may be realized with considerable low mechanical effort.

An embodiment is directed to a method for the operation of a motor vehicle lock as described herein.

In an embodiment, before the two actuation elements interact with each other, those two actuation elements are being adjusted to each other by the transition element. All explanations described herein are also applicable to the method.

In an embodiment, a motor vehicle lock for a motor vehicle door arrangement, wherein an actuation chain is provided for performing an actuation cycle, which actuation chain may be brought into different operational states, wherein the actuation chain comprises a moveable first actuation element and a moveable second actuation element, wherein the actuation chain comprises a moveable transition element and wherein during a first actuation phase of the actuation cycle the transition element interacts with at least one of said actuation elements, in particular with both actuation elements, and thereby adjusts the two actuation elements relative to each other, wherein in a subsequent actuation phase of the actuation cycle the first actuation element, depending on the operational state, drives the second actuation element, is provided.

In an embodiment, the motor vehicle lock comprises a catch and a pawl, which is assigned to the catch, wherein the catch can be brought into an opening position and into a closed position, wherein the catch, which is in the closed position, is or may be brought into holding engagement with a lock striker, wherein the pawl may be brought into an engagement position, in which it is in blocking engagement with the catch, wherein the actuation cycle of the actuation chain causes the pawl to be deflected into a release position, in which it releases the catch, for opening of the motor vehicle lock.

In an embodiment, the second actuation element is assigned to the pawl and that the adjustment of the two actuation elements relative to each other causes a deflection movement of the pawl into the direction of its release position, in particular, that the deflection movement of the pawl is between 20% and 40%, such as 30%, of the release deflection movement of the pawl.

In an embodiment, one operational state is a coupling operational state, in which the second actuation element is coupled to the first actuation element, such that the first actuation element drives the second actuation element during the actuation cycle, and that another operational state is a decoupling operational state, in which the second actuation element is decoupled from the first actuation element, such that the first actuation element runs free with respect to the second actuation element, such that in the coupling operational state the second actuation element is in the path of movement of the first actuation element, such that the first actuation element drives the second actuation element during the actuation cycle, and that in the decoupling operational state the second actuation element is outside the path of movement of the first actuation element, such that the first actuation element runs free with respect to the second actuation element.

In an embodiment, the first actuation element comprises a driving contour and the second actuation element comprises a counter contour and wherein during the actuation cycle, depending on the operational state of the actuation chain, the first actuation element drives the second actuation element by engagement of the driving contour and the counter contour. In some embodiments, during the actuation cycle, in the coupled operational state, the first actuation element drives the second actuation element via the engagement of the driving contour with the counter contour, and, in the decoupled operational state, the first actuation element runs free with respect to the second actuation element, the driving contour missing the counter contour.

In an embodiment, during a second actuation phase of the actuation cycle following the first actuation phase of the actuation cycle, depending on an actuation rapidity and/or a lock state of a lock mechanism, the actuation chain enters the coupled operational state of the actuation chain or the decoupled operational state of the actuation chain.

In an embodiment, the second actuation phase is an engagement free movement of the first actuation element with respect to the second actuation element, wherein the extension of the engagement free movement is defined by the adjustment of the actuation elements during the first actuation phase.

In an embodiment, during the second actuation phase, an inertial characteristic of the first actuation element causes a deflection movement of the first actuation element along a free-wheeling path producing the decoupled operational state, when an actuation movement surpasses a rapidity threshold, and causes a deflection movement of the first actuation element along an engagement path producing the coupled operational state, when the actuation movement is below the rapidity threshold.

In an embodiment, the first actuation element comprises a pivotable actuation lever and a deflection lever pivotably linked to the actuation lever, such that the deflection lever comprises a driving contour for the engagement with a counter contour of the second actuation element.

In an embodiment, the deflection lever is pretensioned by a spring arrangement, which spring arrangement, during the second actuation phase, urges the deflection lever from a position not engaged with the second actuation element into the direction of engagement with the second actuation element, and that the spring arrangement is adapted to an inertial characteristic of the first actuation element such that the inertial characteristic of the first actuation element causes a deflection movement of the first actuation element along a free-wheeling path producing the decoupled operational state, when an actuation movement surpasses a rapidity threshold.

In an embodiment, the transition element comprises a pivotable transition lever, such that the transition element axis is fixedly arranged, or, that the transition element axis is arranged on the first actuation element or on the second actuation element.

In an embodiment, during the first actuation phase, a guide contour of the first actuation element, such as an actuation lever of the first actuation element, slidingly engages a counter guide contour of the transition element, pivoting the transition element and thereby adjusting the second actuation element relative to the first actuation element.

In an embodiment, a part of the first actuation element, the deflection lever of the first actuation element, is free from the transition element.

In an embodiment, the adjustment of the two actuation elements to each other defines the adjustment of the position of the driving contour and the counter contour relative to each other.

In an embodiment, during a third actuation phase of the actuation cycle following the second actuation phase of the actuation cycle, depending on the operational state of the actuation chain, the first actuation element drives the second actuation element or the first actuation element runs free with respect to the secand actuation element.

In an embodiment, a lock mechanism is provided, which may be brought into different locking states like “unlocked” and “locked” and which is coupled to the actuation chain for controlling the operational state of the actuation chain dependent from the lock state.

In an embodiment, the lock mechanism, when in the lock state “locked”, acts on at least one actuation element to prevent the actuation chain to enter the coupled operational state.

In an embodiment, the lock mechanism, when in the lock state “locked”, acts on the transition element to adjust the actuation elements relative to each other during the first actuation phase such that the actuation chain entering the coupled operational state is prevented.

In an embodiment, during the second actuation phase, once the actuation chain has entered the coupled operational state, a play between the first actuation element and the second actuation element remains, which is run through during further actuation during the second actuation phase the play is effective between the driving contour of the first actuation element and the counter contour of the second actuation element.

In an embodiment, a method for the operation of a motor vehicle lock for a motor vehicle door arrangement as described herein, wherein an actuation chain is provided for performing an actuation cycle, which actuation chain may be brought into different operational states, wherein the actuation chain comprises a moveable first actuation element and a moveable second actuation element, wherein the actuation chain comprises a moveable transition element and wherein during a first actuation phase of the actuation cycle the transition element interacts with at least one of said actuation elements, in particular with both actuation elements, and thereby adjusts the two actuation elements relative to each other, wherein in a subsequent actuation phase of the actuation cycle the first actuation element, depending on the operational state, drives the second actuation element is provided.

### BRIEF DESCRIPTION OF THE FIGURES

In the following, the invention will be described in an example referring to the drawings. In the drawings

FIG. 1 shows the relevant parts of a proposed motor vehicle lock with the actuation chain not being actuated a) in front view and b) in back view,

FIG. 2 shows the motor vehicle lock according to FIG. 1 during the first actuation phase of a normal actuation cycle a) in front view and b) in back view,

FIG. 3 shows the motor vehicle lock according to FIG. 2 during the second actuation phase of a normal actuation cycle a) in front view and b) in back view,

FIG. 4 shows the motor vehicle lock according to FIG. 1 during the third phase of a normal actuation cycle a) in front view and b) in back view, and

FIG. 5 shows the motor vehicle lock according to FIG. 1 during the third phase of a crash induced actuation cycle a) in front view and b) in back view.

### DETAILED DESCRIPTION

Referring to the figures, in the depicted embodiment, the motor vehicle lock is assigned to a motor vehicle door arrangement which comprises a motor vehicle door (not shown) beside the motor vehicle lock 1. Regarding the broad interpretation of the expression “motor vehicle door” reference is made to the introductory part of the specification. In this example, the motor vehicle door is a side door of a motor vehicle.

The motor vehicle lock 1 comprises an actuation chain 2, which is provided for performing an actuation cycle. Here, the actuation chain 2 establishes a mechanical connection between a door handle 3, here an outer door handle 3, and a locking element of the motor vehicle lock 1 to be explained later. The motor vehicle lock 1 may be opened by the door handle 3 via the actuation chain 2, if the actuation chain 2 is in the respective operational state. As will be explained later, the actuation chain 2 may be brought into different operational states, which can define, whether the motor vehicle lock 1 may be opened by the door handle 3 or not.

The actuation chain 2 comprises a movable first actuation element 4 and a movable second actuation element 5, which here may interact with each other for transferring and actuation movement induced by the door handle 3.

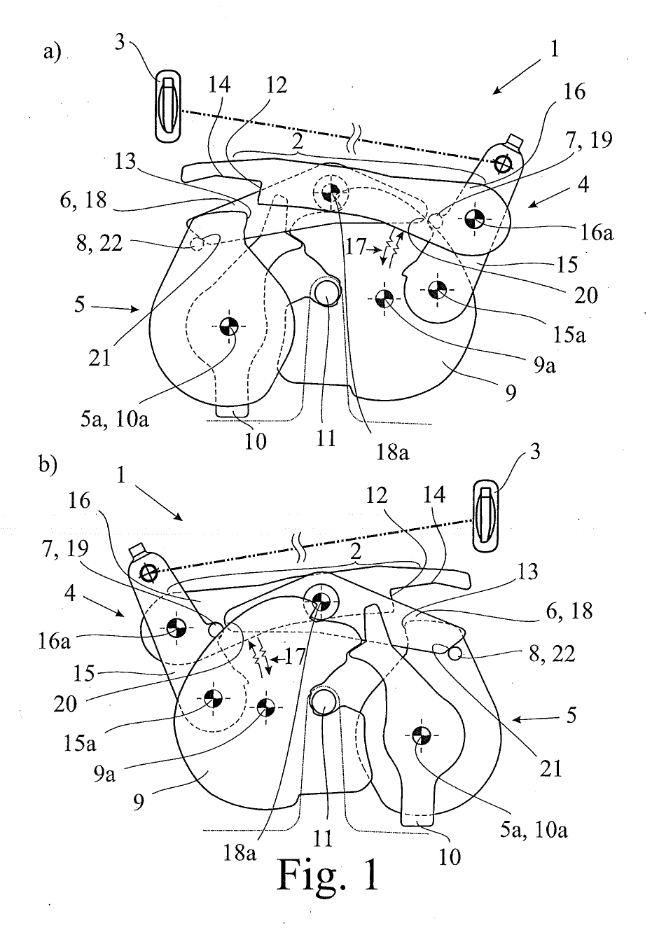

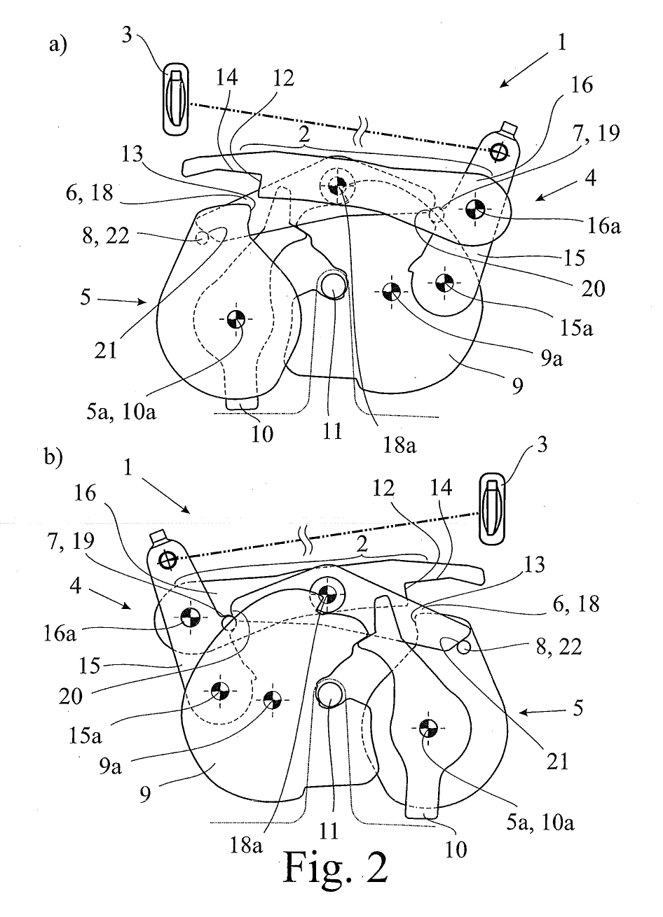

The actuation chain 2 also comprises a movable transition element 6, which is of particular importance for the teaching of the present invention. During a first actuation phase of the actuation cycle the transition element 6 interacts with at least one of the above noted actuation elements 4, 5, here with both actuation elements 4, 5. The first actuation phase of the actuation cycle corresponds to the sequence of FIGS. 1 and 2. For the engagement with the transition element 6, the first actuation element 4 comprises an engagement element 7. Accordingly, for the engagement with the transition element 6, the second actuation element 5 comprises a corresponding engagement element 8 as well. Both engagement elements 7, 8 are here realized as pins. By coming into engagement with the two actuation elements 4, 5, the transition element 6 adjusts the two actuation elements 4, 5 relative to each other. In further detail, looking at the sequence of FIGS. 1 and 2, the engagement element 7 of the first actuation element 4 interacts with the transition element 6, pivoting the transition element 6 in FIG. 1a counter clockwise, which leads to the transition element 6 engaging the engagement element 8 of the second actuation element 5, pivoting the second actuation element 5 counter clockwise as well. FIG. 2 shows, that in the end the relative position of the two engagement elements 7, 8 to each other is defined only by the geometry and the position of the transition element 6. Tolerances, that may go back for example on tolerances in the first actuation element 4 or the second actuation element do not play a role for the relative position of the two engagement elements 7, 8 to each other. The adjustment of the actuation elements 4, 5 according to the invention as a result allows a relative positioning of the two actuation elements 4, 5 to each other widely independent from tolerances that go back on the two actuation elements 4, 5.

As will be explained later, in a subsequent actuation phase of the actuation cycle, the first actuation element 4, depending on the operational state, drives the second actuation element 5. The first actuation phase as described above provides a perfect starting point for all following actuation phases as the positioning of the actuation elements 4, 5 relative to each other has been exactly set by the transition element 6 independently from tolerances, that go back on the two actuation elements 4, 5.

The actuation chain 2 according to the invention may be applied to any function of the motor vehicle lock 1. However, here, the actuation chain 2 serves to open the motor vehicle lock 1. In the drawings the motor vehicle lock comprises a catch 9 pivotable around a pivot axis 9a and a pawl 10 pivotable around a pivot axis 10a, which pawl 10 is assigned to the catch 9. The catch 9 may be brought into an opening position (not shown) and into a closed position (shown in all Figs.), wherein the catch 9, which is in the closed position, is or may be brought into holding engagement with a lock striker 11. In most cases, the motor vehicle lock 1 is arranged at the motor vehicle door, while the lock striker 11 is arranged at the vehicle body.

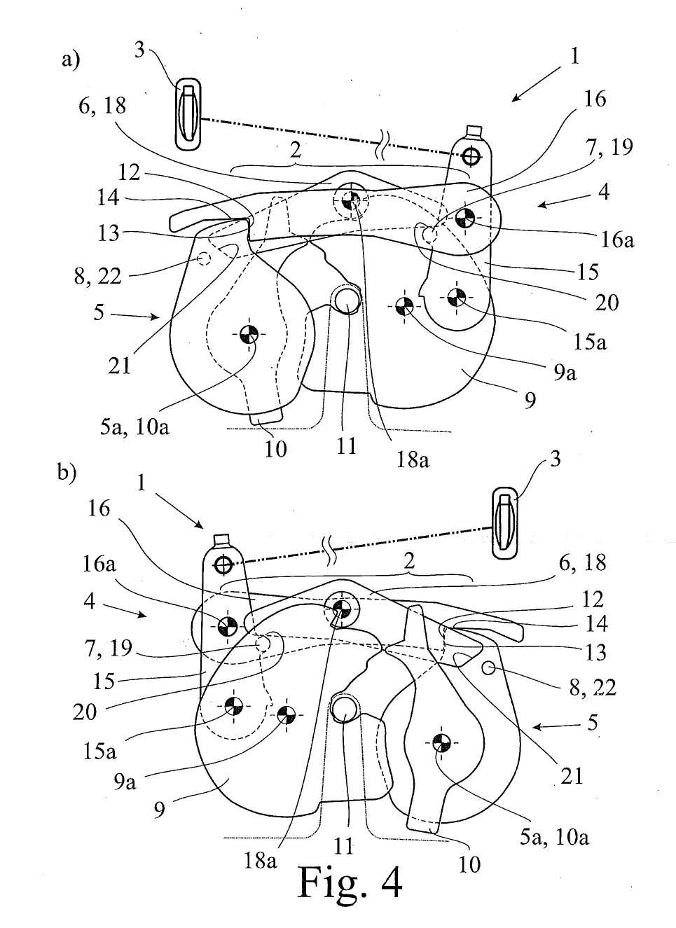

The pawl 10 may be brought into an engagement position shown in FIGS. 1, 2, 3, 5, in which it is in blocking engagement with the catch 9. The actuation cycle of the actuation chain 2 causes the pawl 10 to be deflected into a release position, which deflection is a movement of the pawl 10 in FIG. 1a in counter clockwise direction. In the release position (FIG. 4) the pawl 10 releases the catch 9 for opening of the motor vehicle lock 1. With the pawl 10 in the release position shown in FIG. 4, the catch 9 may pivot in FIG. 4a in counter clockwise direction, freeing the clock striker 11 and as a result freeing the motor vehicle door.

Interesting is the fact that the second actuation element 5 here \ is assigned to the pawl 10. In fact the second actuation element 5 is fixedly connected to the pawl 10. The above noted adjustment of the two actuation elements 4, 5 relative to each other causes a deflection movement of the pawl 10 into the direction of its release position. This may be taken from the sequence of FIGS. 1 and 2. FIG. 2 shows, that during the first actuation phase of the actuation cycle the deflection movement of the pawl 10 is only a part of the release deflection movement of the pawl 10, which would lead to the pawl 10 reaching its release position. Here the deflection movement of the pawl 10 is between 20% and 40%, such as 30%, of the release deflection movement of the pawl 10.

The above noted, partly releasing the pawl 10 is interesting as the first actuation phase now serves two purposes. One purpose is to adjust the two actuation elements 4, 5 relative to each other. The second purpose is to partly release the pawl 10, which means that in the above noted, subsequent actuation phase the pawl 10 has to be deflected only over a low distance, which reduces the necessary actuation movement of the door handle 3 during an actuation cycle.

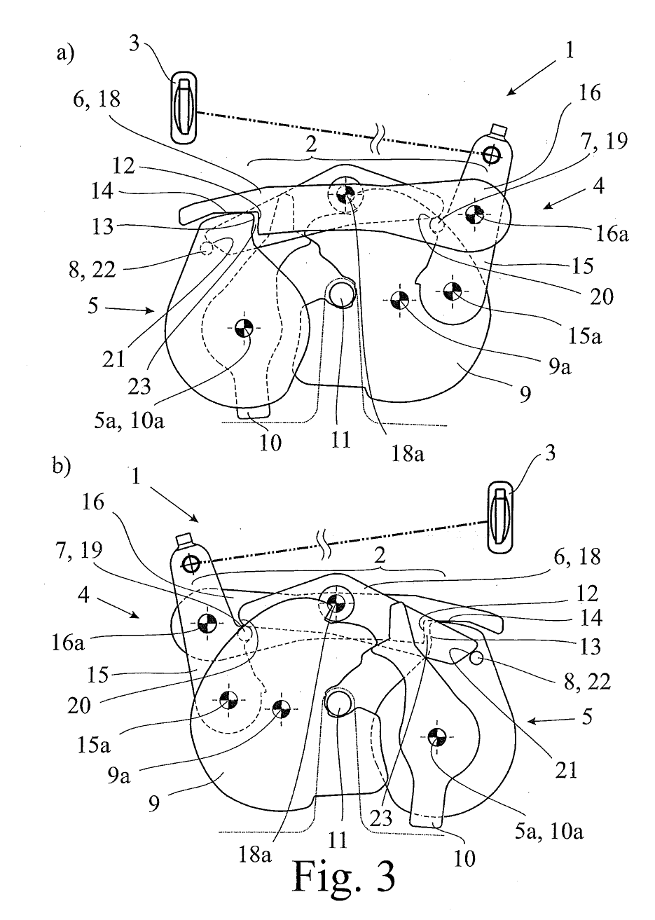

As noted above, there are different operational states possible for the actuation chain 2. Here, one operational state is a coupling operational state, in which the second actuation element 5 is coupled to the first actuation element 4, such that the first actuation element 4 drives the second actuation element 5 during the actuation cycle. The coupled operational state is shown in FIG. 3, while the driving action may be taken from the sequence of FIGS. 3 and 4.

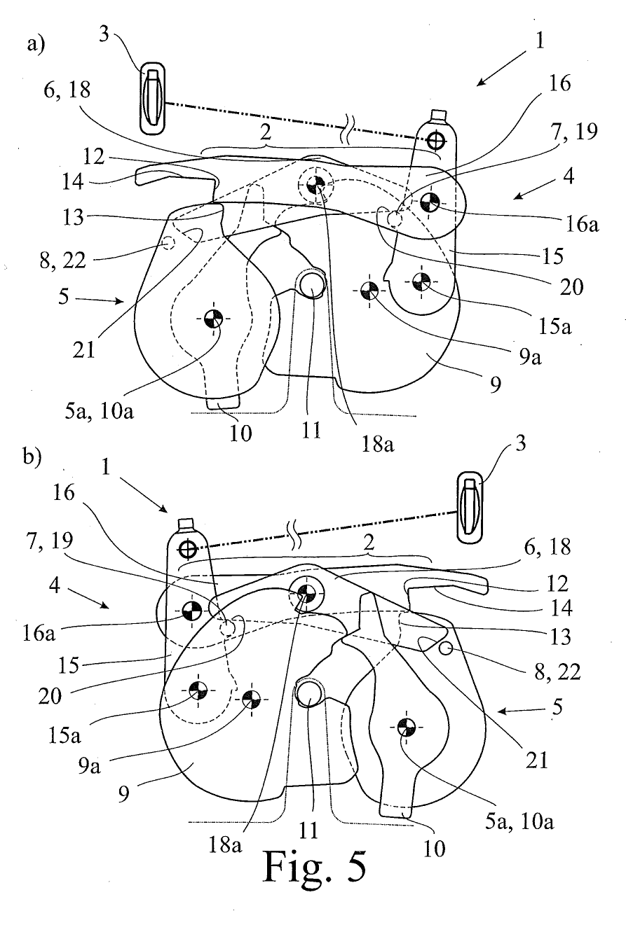

Here, a second operational state is a decoupling operational state, in which the second actuation element 5 is decoupled from the first actuation element 4, such that the first actuation element 4 runs free with respect to the second actuation element 5. The decoupling operational state is shown in FIGS. 1 and 2, while the running free action is shown in FIG. 5.

In further detail, in the coupling operational state (FIG. 3, 4) the second actuation element 5 is in the path of movement of the first actuation 4, such that the first actuation element 4 drives the second actuation element 5 during the actuation cycle. Accordingly, in the decoupling operational state (FIG. 1, 2, 5), the second actuation element 5 is outside the path of movement of the first actuation element 4, such that the first actuation element 4 runs free with respect to the second actuation element 5.

Again in a more detailed view, the first actuation element 4 comprises a driving contour 12 and the second actuation element 5 comprises a counter contour 13, which driving contour 12 defines a step like form together with wall segment 14.

During the actuation cycle, depending on the operational state of the actuation chain 2, the first actuation element 4 drives the second actuation element 5 by engagement of the driving contour 12 and the counter contour 13. In an embodiment, during the actuation cycle, in the coupled operational state, the first actuation element 4 drives the second actuation element 5 via the engagement of the driving contour 12 with the counter contour 13, and, in the decoupled operational state, the first actuation element 4 runs free with respect to the second actuation element 5, the driving contour 12 missing and thereby passing by the counter contour 13.

The above noted adjustment of the two actuation elements 4, 5 is valuable for the second actuation phase of the actuation cycle, which is here immediately following the first actuation phase of the actuation cycle. In the shown embodiment the second actuation phase of the actuation cycle provides a crash function. During this second actuation phase of the actuation cycle, which follows the first actuation phase of the actuation cycle, depending on an actuation rapidity, the actuation chain 2 enters the coupled operational state of the actuation chain 2 or the decoupled operational state of the actuation chain 2. For realizing the crash function, this means, that a high actuation rapidity leads to the actuation chain 2 entering the decoupled operational state of the actuation chain 2, such that the actuation movement, induced for example by high crash accelerations, runs free.

In addition or as an alternative, during the second actuation phase of the actuation cycle, depending on a lock state of a lock mechanism, the actuation chain 2 enters the coupled operational state of the actuation chain 2 or the decoupled operational state of the actuation chain 2. In this case the lock mechanism 14 serves for setting a lock state as “locked” and “unlocked”, which lock states are usually realized in motor vehicle locks 1.

The second actuation phase, which may be taken from the sequence of FIGS. 2 and 3, here is an engagement free movement of the first actuation element 4 with respect to the second actuation element 5, which means, that the first actuation element 4 does not directly interact with the second actuation element 5. The sequence shown in FIGS. 1, 2 and 3 shows that the extension of the engagement free movement is defined by the adjustment of the actuation elements 4, 5 during the first actuation phase.

The above noted crash function during the second actuation phase works as follows: During the second actuation phase, an inertial characteristic of the first actuation element 4 causes a deflection movement of the first actuation element 4 along a free-wheeling pass producing the decoupled operational state, when an actuation movement surpasses a rapidity threshold. This situation during the second actuation phase is not shown in the drawings. However, it corresponds to the situation shown in FIG. 3 with the exception that the driving contour 12 of the first actuation element 4 is in the position shown in FIG. 2.

Further, during the second actuation phase, an inertial characteristic of the first actuation element 4 causes a deflection movement of the first actuation element 4 along an engagement path producing coupled operational state, when the actuation movement is below the rapidity threshold. This situation is shown in FIG. 3.

The above noted function corresponds to the function of the motor vehicle lock 1 shown in U.S. patent application Ser. No. 13/929,258, filed Mar. 25, 2013. The disclosure of this US patent application, which goes back on the applicant, is hereby fully integrated into the present patent application.

Here, the first actuation element 4 is a two-part component. The first actuation element 4 accordingly comprises an actuation lever 15 pivotable around a pivot axis 15a and a deflection lever 16, which is pivotably linked to the actuation lever 15 around a pivot axis 16a. Further, the deflection lever 16 comprises a driving contour 12 for the engagement with a counter contour 13 of the second actuation element 5 as noted above.

In order to achieve the above noted characteristic of the first actuation element 4 during the second actuation phase the first actuation element 4 is assigned a spring arrangement 17, which function is explained in detail in the above noted US patent application as well.

The deflection lever 16 of the first actuation element 4 is pretensioned by the above noted spring arrangement 17, which spring arrangement 17, during the second actuation phase, urges the deflection lever 16 from a position not engaged with the second actuation element 5 into the direction of engagement with the second actuation element 5. The spring arrangement 17 is adapted to an inertial characteristic of the first actuation element 4 such that the inertial characteristic of the first actuation element 4 causes a deflection movement of the first actuation element 4 along a free-wheeling path producing the decoupled operational state, when an actuation movement surpasses a rapidity threshold. Again, reference is to be made to the above noted US patent application.

For the mechanical realization of the transition element 6 there are different alternatives possible. Here, the transition element 6 comprises a transition lever 18 pivotable around a pivot axis 18a. In the shown embodiment the transition element axis 6a is fixedly arranged, in particular is fixed to a housing part of the motor vehicle lock 1. As an alternative, the transition element axis 6a may be arranged on the first actuation element 4 or on the second actuation element 5.

According to an embodiment shown in the drawings the transition element 6 is a two-arm lever. Generally it is possible that the transition element is a one-arm lever or any other construction. It may as well be advantageous that the transition element 6 is a float-mounted element.

The engagement between the actuation elements 4, 5 and the transition element 6 is going back on a sliding engagement. Accordingly, during the first actuation phase, a guide contour 19 of the first actuation element 4, which is provided by the above noted engagement element 7, slidingly engages a counter guide contour 20 of the transition element 6, pivoting the transition element 6 and thereby adjusting the second actuation element 5 relative to the first actuation element.

For this adjustment, the transition element 6 comprises a second counter guide contour 21, which slidingly engages the guide contour 22 of the second actuation element 5, which again is provided by the above noted engagement element 8.

Looking at FIGS. 1, 2 and 3 it appears that a part of the first actuation element 4, here the deflection lever 16 of the first actuation element 4, is always free from the transition element 6. This means that even during the transition element 6 holding the two actuation elements 4, 5 in place relative to each other, the deflection lever 16 may perform the above noted crash function without being hindered by the transition element 6.

It may be pointed out that the adjustment of the two actuation elements 4, 5 mainly serves to guarantee an exact positioning of the driving contour 12 and the counter contour 13 relative to each other, in order to guarantee a reliable crash function as explained above. It goes without saying that tolerances occurring between the driving contour 12 and the counter contour 13 will have an undesireable impact on the crash function rendering the crash function unreliable.

After the adjustment of the actuation elements 4, 5 relative to each other has been performed during the first actuation phase and after the crash function has been performed during the second actuation phase, a third actuation phase is provided, which here follows the second actuation phase immediately. During the third actuation phase, which follows the second actuation phase, depending on the operational state of the actuation chain 2, the first actuation element 4 drives the second actuation element 5 (FIG. 4) or the first actuation element 4 runs free with respect to the second actuation element 5 (FIG. 5). This means that during the third actuation phase, the pawl 10 is being released, if the operational state is the coupled operational state as shown in FIG. 4. If the operational state is the decoupled operational state, during the third actuation phase, the first actuation element 4 runs free as shown in FIG. 5.

In the shown embodiment the second actuation phase serves the realization of the above noted crash function. The coupled operational state and the decoupled operational state is entered dependent from the rapidity of the actuation movement. For guaranteeing a reliable crash function the above noted adjustment is performed during the first actuation phase.

However, the adjustment during the first actuation phase may well be used for realizing lock states like “unlocked” and “locked”. For this a lock mechanism (not shown) is provided, which may be brought into different lock states like “unlocked” and “locked” and which is coupled to the actuation chain 2 for controlling the operational state of the actuation chain 2 dependent from the lock state. For example, it may be provided, that the lock mechanism, when in the lock state “locked”, acts on the transition element 6 to adjust the actuation elements 4, 5 relative to each other during the first actuation phase such that the actuation chain 2 entering the coupled operational state is prevented. This means that the relative position between the driving contour 12 and the counter contour 13 after the adjustment is such that during the second actuation phase the driving contour 12 can only pass by the counter contour 13, if the lock mechanism is in the lock state “locked”. If the lock mechanism is in the lock state “unlocked”, the adjustment of the actuation elements 4, 5 is being performed as shown in FIG. 2. Accordingly, during the second actuation phase the driving contour 12 may well come into engagement with the counter contour 13, which allows the first actuation element 4 to drive the second actuation element 5 as explained above.

FIG. 3 shows that during the second actuation phase, once the actuation chain 2 has entered the coupled operational state, a play 23 between the first actuation element 4 and the second actuation element 5 remains, which is run through during further actuation during the second actuation phase. Here this play 23 is effective between the driving contour 12 of the first actuation element 4 and the counter contour 13 of the second actuation element 5. Looking at the FIGS. 2 and 3 in combination, it becomes clear that a certain play 23 is necessary for the driving contour 12 being able to come into engagement with the counter contour 13. However, with the proposed adjustment of the two actuation elements 4, 5 relative to each other, it is possible to reduce this play, as the usual tolerances have not to be taken into account as noted above.

Also described herein is a method for the operation of the proposed motor vehicle lock 1. It is of particular importance for the method that before the actuation elements 4, 5 interact with each other as explained earlier, the proposed adjustment is to be performed with the transition element 6. All explanations given regarding the proposed motor vehicle lock 1 are fully applicable to the method.

1. A motor vehicle lock for a motor vehicle door arrangement, wherein an actuation chain is provided for performing an actuation cycle, which actuation chain may be brought into different operational states, wherein the actuation chain comprises a moveable first actuation element and a moveable second actuation element, wherein the actuation chain comprises a moveable transition element and wherein during a first actuation phase of the actuation cycle the transition element interacts with at least one of said actuation elements and thereby adjusts the two actuation elements relative to each other, wherein in a subsequent actuation phase of the actuation cycle the first actuation element, depending on the operational state, drives the second actuation element.

2. The motor vehicle lock according to claim 1, wherein the motor vehicle lock comprises a catch and a pawl, which is assigned to the catch, wherein the catch can be brought into an opening position and into a closed position, wherein the catch, which is in the closed position, is or may be brought into holding engagement with a lock striker, wherein the pawl may be brought into an engagement position, in which it is in blocking engagement with the catch, wherein the actuation cycle of the actuation chain causes the pawl to be deflected into a release position, in which it releases the catch, for opening of the motor vehicle lock.

3. The motor vehicle lock according to claim 1, wherein the second actuation element is assigned to the pawl and that the adjustment of the two actuation elements relative to each other causes a deflection movement of the pawl into the direction of its release position.

4. The motor vehicle lock according to claim 1, wherein one operational state is a coupling operational state, in which the second actuation element is coupled to the first actuation element, such that the first actuation element drives the second actuation element during the actuation cycle, and that another operational state is a decoupling operational state, in which the second actuation element is decoupled from the first actuation element, such that the first actuation element runs free with respect to the second actuation element.

5. The motor vehicle lock according to claim 1, wherein the first actuation element comprises a driving contour and the second actuation element comprises a counter contour and wherein during the actuation cycle, depending on the operational state of the actuation chain, the first actuation element drives the second actuation element by engagement of the driving contour and the counter contour.

6. The motor vehicle lock according to claim 1, wherein during a second actuation phase of the actuation cycle following the first actuation phase of the actuation cycle, depending on an actuation rapidity and/or a lock state of a lock mechanism, the actuation chain enters the coupled operational state of the actuation chain or the decoupled operational state of the actuation chain.

7. The motor vehicle lock according to claim 1, wherein the second actuation phase is an engagement free movement of the first actuation element with respect to the second actuation element, wherein the extension of the engagement free movement is defined by the adjustment of the actuation elements during the first actuation phase.

8. The motor vehicle lock according to claim 1, wherein during the second actuation phase, an inertial characteristic of the first actuation element causes a deflection movement of the first actuation element along a free-wheeling path producing the decoupled operational state, when an actuation movement surpasses a rapidity threshold, and causes a deflection movement of the first actuation element along an engagement path producing the coupled operational state, when the actuation movement is below the rapidity threshold.

9. The motor vehicle lock according to claim 1, wherein the first actuation element comprises a pivotable actuation lever and a deflection lever pivotably linked to the actuation lever.

10. The motor vehicle lock according to claim 1, wherein the deflection lever is pretensioned by a spring arrangement, which spring arrangement, during the second actuation phase, urges the deflection lever from a position not engaged with the second actuation element into the direction of engagement with the second actuation element, and that the spring arrangement is adapted to an inertial characteristic of the first actuation element such that the inertial characteristic of the first actuation element causes a deflection movement of the first actuation element along a free-wheeling path producing the decoupled operational state, when an actuation movement surpasses a rapidity threshold.

11. The motor vehicle lock according to claim 1, wherein the transition element comprises a pivotable transition lever.

12. The motor vehicle lock according to claim 1, wherein during the first actuation phase, a guide contour of the first actuation element slidingly engages a counter guide contour of the transition element, pivoting the transition element and thereby adjusting the second actuation element relative to the first actuation element.

13. The motor vehicle lock according to claim 1, wherein a part of the first actuation element is free from the transition element.

14. The motor vehicle lock according to claim 1, wherein the adjustment of the two actuation elements to each other defines the adjustment of the position of the driving contour and the counter contour relative to each other.

15. The motor vehicle lock according to claim 1, wherein during a third actuation phase of the actuation cycle following the second actuation phase of the actuation cycle, depending on the operational state of the actuation chain, the first actuation element drives the second actuation element or the first actuation element runs free with respect to the second actuation element.

16. The motor vehicle lock according to claim 1, wherein a lock mechanism is provided, which may be brought into different locking states like “unlocked” and “locked” and which is coupled to the actuation chain for controlling the operational state of the actuation chain dependent from the lock state.

17. The motor vehicle lock according to claim 16, wherein the lock mechanism, when in the lock state “locked”, acts on at least one actuation element to prevent the actuation chain to enter the coupled operational state.

18. The motor vehicle lock according to claim 16, wherein the lock mechanism, when in the lock state “locked”, acts on the transition element to adjust the actuation elements relative to each other during the first actuation phase such that the actuation chain entering the coupled operational state is prevented.

19. The motor vehicle lock according to claim 1, wherein during the second actuation phase, once the actuation chain has entered the coupled operational state, a play between the first actuation element and the second actuation element remains, which is run through during further actuation during the second actuation phase.

20. A method for the operation of a motor vehicle lock for a motor vehicle door arrangement according to claim 1 wherein an actuation chain is provided for performing an actuation cycle, which actuation chain may be brought into different operational states, wherein the actuation chain comprises a moveable first actuation element and a moveable second actuation element, wherein the actuation chain comprises a moveable transition element and wherein during a first actuation phase of the actuation cycle the transition element interacts with at least one of said actuation elements and thereby adjusts the two actuation elements relative to each other, wherein in a subsequent actuation phase of the actuation cycle the first actuation element, depending on the operational state, drives the second actuation element.
